(19) United States
(12) Patent Application Publication
(10) Pub. No.: US 2012/0127748 A1
(43) Pub. Date: May 24, 2012

(54) LIGHT-CONCENTRATING DEVICE USING MULTI-OPTIC CABLES

(76) Inventor: Hyuck-jung Kim, Chungcheongnam-do (KR)

(21) Appl. No.: 13/387,009

(22) PCT Filed: Jul. 29, 2010
(86) PCT No.: PCT/KR10/04979

§ 371 Date: Jan. 25, 2012

(30) Foreign Application Priority Data
Jul. 29, 2009 (KR) 10-2009-0069150

(51) Int. Cl. F21V 8/00

(52) U.S. Cl. 362/555

(57) ABSTRACT

Disclosed is a light-concentrating device using multiple optical-cables in which beams of light output from a plurality of light sources are combined into one beam of light and condensed so that a focal point is formed at a desired position, to secure necessary illumination intensity at a desired remote position from the light sources, in which a focal angle of a condenser lens is adjusted so that the device exhibits a desired illumination intensity and/or desired light distribution property at a place distant from the light sources by a desired distance, and, hence, in which the device may be widely used, for example, to light a museum, swimming pool, building outer wall or building floor or bridge, or as a lighting device for a semiconductor manufacturing process or surgical operation, etc. To this end, the light-concentrating device using the multiple optical-cables includes a body, an LED module, a plurality of multi-optical-fibers, an optical-cable adaptor, an illumination intensity optical-cable and a condenser lens adjustment unit.

### CROSS-REFERENCE TO RELATED APPLICATION(S)

This application claims priority to, and is a US national stage entry of PCT application PCT/KR2010/004979 filed on Jul. 7, 2010 incorporated herein by reference, which in turn claims the benefit of Korean Patent Application No. 10-2009-0069150, filed on 29 Jul. 2009 in the Korean Intellectual Property Office, the disclosure of which is incorporated herein by reference.

### BACKGROUND OF THE DISCLOSURE

1. Field of the Disclosure

Embodiments of the disclosure relate to a light-concentrating device using multiple optical-cables in which individual beams of light output from a plurality of light sources are collected at one place and combined into one combined beam of light using the multiple optical-cables, the combined beam of light is directed to a desired place in a condensed state so that a focal point is formed at the place, and, hence, in which the device may be widely used, for example, to light a museum, swimming pool, building outer wall or building floor, or bridge, or as a lighting device for a semiconductor manufacturing process or surgical operation, etc.

2. Description of the Related Art

Generally, electrical bulbs, fluorescent lamps, etc. have been widely used for indoor or outdoor lighting. However, electrical bulbs, fluorescent lamps, etc. have a short lifespan and thus must be frequently replaced.

In addition, conventional fluorescent lamps frequently suffer from deterioration in light output over the course of their lifespan.

To solve such problems, employing LEDs (Light Emitting Diode) as a lighting device has been approached. LEDs have superior control characteristic, fast response rate, high electro-optical conversion efficiency, long lifespan, lower power consumption and high brightness.

In case of a conventional lighting device using LEDs, beams of light from respective LEDs directly diffuse and are emitted to an illuminated place, resulting in light attenuation on a diffusion path. Therefore, sufficient illumination intensity may not be secured at an illuminated place distant from the LEDs.

That is, since the LEDs have low output, satisfactory illumination intensity may not be obtained at a desired illuminated place which is distant from the LEDs by long light diffusion distance.

Recently, to solve such a problem, a lighting device using LEDs having high output has been developed. The lighting device using LEDs having the high output provides satisfactory illumination intensity at the illuminated place. However, since heat may be generated from the LEDs, it requires a separate and complex heat-discharge device including radiation fins and a blowing fan to discharge heat from the LEDs. Thus, the resultant lighting device may suffer from high price and poor luminous efficacy, thus being poorly suited to commercialization.

Moreover, among other things, an existing LED lighting device is only formed with a single light source and, thus, illuminated places are limited to small areas. Therefore, illumination intensity thereof at the illuminated place may be lower than that of the electrical bulb or fluorescent lamp. Since the existing LED lighting device may not include an adjustment apparatus to adjust a distance between the LED and a condenser lens, desired illumination intensity and light distribution may not be achieved.

### SUMMARY OF THE DISCLOSURE

In order to solve such problems, the disclosure provides a light-concentrating device using multiple optical-cables in which beams of light output from a plurality of light sources are combined into one beam of light to secure necessary illumination intensity at a remote position from the light sources, in which a focal angle formed by a condenser lens is adjusted so that a desired illumination intensity and/or light distribution property are attained at a place distant from the light sources by a desired distance, and, hence, in which the device may be widely used, for example, to light a museum, swimming pool, building outer wall or building floor, or bridge, or as a lighting device for a semiconductor manufacturing process or surgical operation, etc.

To this end, a light-concentrating device using multiple optical-cables according to one aspect of the disclosure may include a body 100 having a rectangular box form; an LED module 200 formed in the body and including a plurality of LED elements to generate a plurality of beams of light respectively; a plurality of multi-optical-fibers 300 directly connected to the corresponding LED elements of the LED module and transferring the beams of light emitted from the LED elements to the optical-cable adaptor; the optical-cable adaptor 400 having one side-end connected to the multi-optical-fibers while having the other side-end connected to an illumination intensity optical-cable and collecting the beams of light output from the multi-optical-fibers and transferring the beams of light to the illumination intensity optical-cable; the illumination intensity optical-cable 500 connected to the optical-cable adaptor to receive the beams of light from the optical-cable adaptor and combine the beams of light into one beam of light and then to transfer one beam of light to a condenser lens; and the condenser lens adjustment unit 600 disposed exactly at an extension line of a length direction of the illumination intensity optical-cable and spaced from an outlet end of the illumination intensity optical-cable and having the condenser lens, wherein the condenser lens adjustment unit condenses one beam of light diffused from the illumination intensity optical-cable using the condenser lens so that a focal point is formed at a particular position to be illuminated and the condenser lens adjustment unit adjusts a focal angle via focus and/or zoom adjustment of the condenser lens.

In accordance with the light-concentrating device using the multiple optical-cables, independent beams of light output from the plurality of light sources are combined into one combined beam of light to secure necessary illumination intensity at a remote position from the light sources. Thus, the light-concentrating device has a wider range of applications than that of a conventional LED lamp. To be specific, the light-concentrating device may be widely used, for example, to light a museum, swimming pool, building outer wall or building floor or bridge, or as a lighting device for a semiconductor manufacturing process or surgical operation, etc.

Other objects, advantages and novel features will become more apparent from the following detailed description taken in conjunction with the accompanying drawings

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating components of a light-concentrating device using multiple optical-cables according to one embodiment;

FIG. 2 is an inner perspective view illustrating components of the light-concentrating device using the multiple optical-cables according to one embodiment;

FIG. 3 is an inner cross-sectional view illustrating components of the light-concentrating device using the multiple optical-cables according to one embodiment;

FIG. 4 is an exemplary perspective view illustrating a state in which a circular insertion tube 310 formed at an inlet end of each of the multi-optical-fibers 300 is coupled to each of LED light-collecting head caps 230, according to one embodiment;

FIG. 5 is a perspective view of a condenser lens adjustment unit 600 according to one embodiment;

FIG. 6 is a disassembled perspective view illustrating components of the condenser lens adjustment unit 600 according to one embodiment;

FIG. 7 is a an inner cross-sectional view illustrating components of the condenser lens adjustment unit 600 according to one embodiment;

FIG. 8 is an exemplary perspective view illustrating a state in which an illumination intensity optical-cable 500 is connected to an optical-cable adaptor 400 to receive beams of light from the adaptor 400, combines the beams of light into one beam of light and then transfers one beam of light to a condenser lens, according to one embodiment;

FIG. 9 is an exemplary perspective view according to one embodiment, illustrating a state in which the condenser lens adjustment unit 600 condenses light diffused from the illumination intensity optical-cable 500 using the condenser lens so that a focal point is formed at a particular position to be illuminated; and

FIG. 10 is an exemplary perspective view illustrating a state in which the light-concentrating devices using the multiple optical-cables according to one embodiment are buried in a ceiling to illuminate an indoor area.

### DESCRIPTION

Reference will now be made in detail to the embodiments, examples of which are illustrated in the accompanying drawings, wherein like reference numerals refer to like elements throughout.

Below, embodiments will be described in detail with reference to the accompanying drawings.

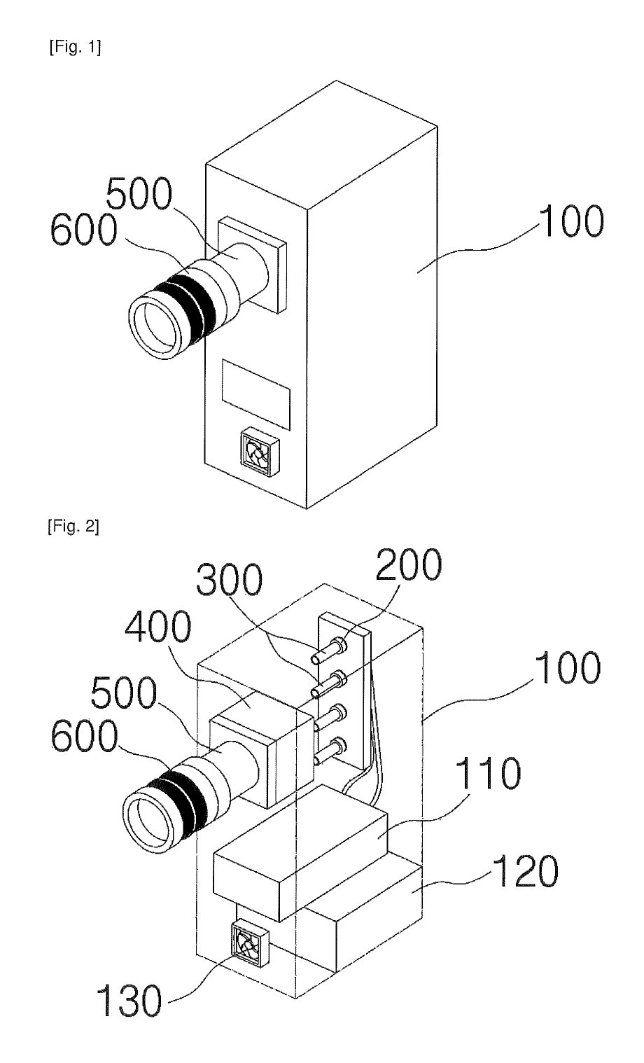

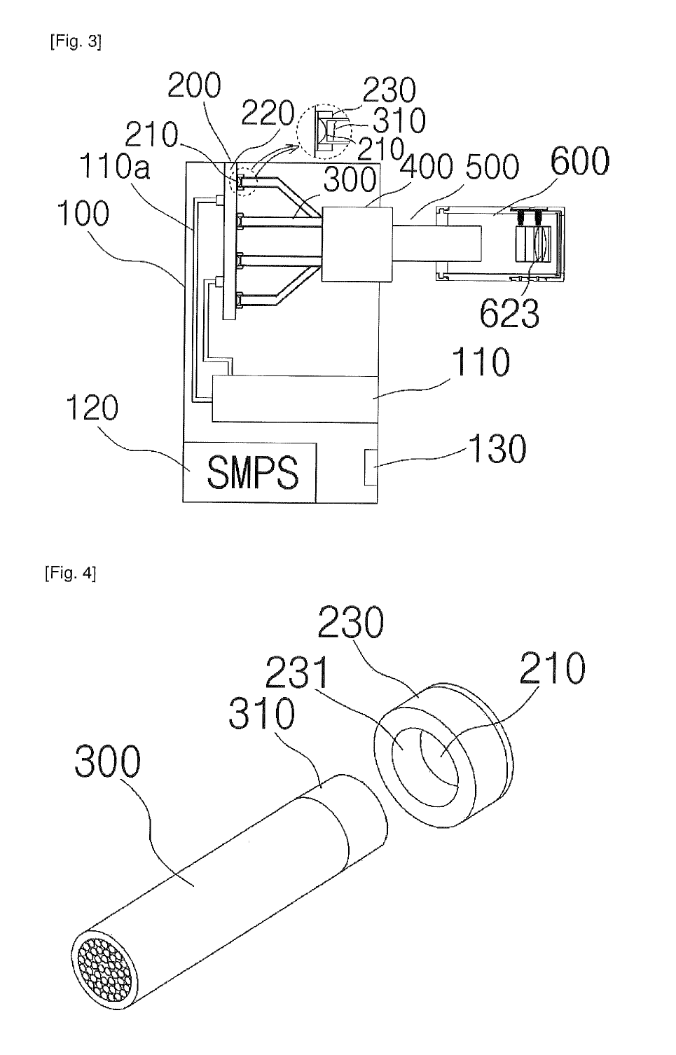

FIG. 1 is a perspective view illustrating components of an LED light-concentrating device using multiple optical-cables according to one embodiment. The LED light-concentrating device includes a body 100, an LED module 200, a plurality of multi-optical-fibers 300, an optical-cable adaptor 400, an illumination intensity optical-cable 500 and a condenser lens adjustment unit 600.

First, the body 100 according to one embodiment will be described.

The body 100 in one embodiment has an elongated rectangular box shape and protects respective components therein from external impact and may be made of an aluminum alloy or thermosetting plastic resin.

Within the body 100 according to one embodiment, an LED module 200 is incorporated. On a rear of the LED module 200, there is provided a cooling unit 110 to cool the module 200 with heat generated from high luminance LEDs of the LED module 200.

On a front of the LED module 200, LED light-collecting head caps 230 are formed. In the respective LED light-collecting head caps 230, the multi-optical-fibers 300 are disposed at respective one-side ends thereof. The respective multi-optical-fibers 300 are inserted into one side of the optical-cable adaptor 400 at the other-side ends thereof. To the other side of the optical-cable adaptor 400, the illumination intensity optical-cable 500 is connected.

At a bottom portion in the body 100 according to one embodiment, a cooling fan 130 is disposed to absorb cool air from the outside of the body and to circulate the same within the body. At a place facing away from the cooling fan 130, a switching mode power supply (SMPS) 120 is disposed.

The SMPS 120 converts alternating current AC from supplied from the outside into direct current (DC) suitable to operate the LED module 200, and supplies, for example, 5 V of converted constant DC to the high luminance LEDs.

Hereinafter, the LED module 200 according to one embodiment will be described in detail.

The LED module 200 serves to generate beams of light and includes the high luminance LEDs 210 and in one embodiment a metal printed circuit board (PCB) 220 to discharge heat generated from the high luminance LEDs 210.

On the metal PCB 220 in one embodiment, there are disposed a constant current unit 220a operating in a pulse width modulation (PWM) manner to supply constant current to the high luminance LEDs 210, and a constant voltage control unit 220b to control the constant voltage output from the SMPS and stably supply the same to the high luminance LEDs 210.

At the front of the metal PCB 220, there are formed a glass epoxy (GE) PCB and a plurality of insertion holes therein to accommodate the high luminance LEDs 210 respectively. Beneath the GE PCB, an insulation pad made of a rubber material is formed. Beneath the insulation pad, a heat discharge plate made of an aluminum material is formed.

In addition, within the metal PCB 220 according to one embodiment a cooling water pipe 110a is formed to cool, using cooling water, remaining heat not yet discharged from the metal PCB 220.

In this way, since the metal PCB 220 includes in one embodiment, beneath the high luminance LEDs 210, the insulation pad made of the rubber material and the heat discharge plate made of the aluminum material and, further, the cooling water pipe 110a is formed in the metal PCB 220, it may be possible to extend the lifespan of the high luminance LEDs 210 having poor heat resistance and, at the same time, to prevent device malfunction due to heat.

The LED module 200 according to one embodiment includes the LED light-collecting head caps 230 at positions respectively in contact with the multi-optical-fibers 300.

Each of the LED light-collecting head caps 230 surrounds a light-emission end of each of the high luminance LEDs and collects beams of light toward a centrally-formed insertion hole by reflecting outside-directed beams of light and guides the collected beams of light to an insertion tube 310 side of each of the multi-optical-fibers 300 inserted into the insertion hole. Further, the LED light-collecting cap 230 serves to support the insertion tube 310.

The LED light-collecting cap 230 may be made of an aluminum material at a periphery of the insertion hole to receive the insertion tube of each of the multi-optical-fibers 300, while the remainder thereof may be made of a rubber material

Now, the multi-optical-fibers 300 according to one embodiment will be described in detail.

The multi-optical-fibers 300 according to one embodiment are directly connected to the corresponding high luminance LEDs of the LED module 200 and transfer beams of light emitted from the LEDs to the optical-cable adaptor 400. Each of the multi-optical-fibers 300 is preferably made of a glass with good transparency.

Each of the multi-optical-fibers 300 according to one embodiment includes a plurality of optical-fibers, each including a core at a cross-sectional central region thereof and a cladding surrounding the core. Thus, the optical-fiber has a dual cylindrical structure.

In addition, on an outer wall surface of the cladding, one protective synthetic resin layer or two protective synthetic resin layers may be formed to cover the cladding to protect the cladding from external impact.

Each of the multi-optical-fibers 300 according to one embodiment may be formed with single mode optical fibers or multi-mode optical fibers, each having 10 to 500 μm (1 μm equals 1/1000 mm) of an entire diameter except for the protection synthetic layer. A refractive index of the cladding is higher than that of the core such that beams of light are concentrated at the core and smoothly propagate toward the optical-cable adaptor 400.

The above-mentioned multi-optical-fibers 300 according to one embodiment may be hardly affected by or interfered with external electromagnetic waves. Moreover, the multi-optical-fibers 300 may be small and light though having excellent durability in spite of a large number of bends.

Each of the multi-optical-fibers 300 according to one embodiment includes the circular-shaped insertion tube 301 which is inserted into the insertion hole of each of the LED light-collecting head caps 230 of the LED module 200. Thus, each of the multi-optical-fibers 300 is coupled to the LED module 200 at a front of the module 200.

Via the respective circular-shaped insertion tubes 310, the multi-optical-fibers 300 are directly connected to the corresponding high luminance LEDs of the LED module 200. For this reason, each of the circular insertion tubes 310 may be made of a glass material at an inner surface thereof in contact with a beam of light emitted from the high luminance LED and be made of a silicon or rubber material at an outer surface thereof.

Next, the optical-cable adaptor 400 according to one embodiment will be described in detail.

The optical-cable adaptor 400 according to one embodiment has one side-end connected to the multi-optical-fibers 300 while having the other side-end connected to the illumination intensity optical-cable 500. The optical-cable adaptor 400 collects beams of light output from the multi-optical-fibers 300 and transfers the same to the illumination intensity optical-cable 500. The optical-cable adaptor 400 has a rectangular box form as shown in FIG. 2.

The optical-cable adaptor 400 according to one embodiment includes multi-optical-fiber connection sockets 410 and an illumination intensity optical-cable connection portion 420.

The multi-optical-fiber connection sockets 410 according to one embodiment are connected to the corresponding multi-optical-fibers 300.

The illumination intensity optical-cable connection portion 420 according to one embodiment is formed in such a manner that the illumination intensity optical-cable 500 is fitted therein. The illumination intensity optical-cable connection portion 420 may transfer beams of light from the multi-optical-fibers 300 through the multi-optical-fiber connection sockets 410 to the illumination intensity optical-cable 500.

Next, the illumination intensity optical-cable 500 according to one embodiment will be described in detail.

The illumination intensity optical-cable 500 according to one embodiment is connected to the optical-cable adaptor 400 to receive beams of light from the optical-cable adaptor 400 and to combine the beams of light into one beam of light and then to transfer the same to a condenser lens 623. The illumination intensity optical-cable 500 includes multi-mode optical fibers, each being formed of a plurality of single-mode optical fibers in a twisted manner each having a diameter of 10 to 80 μm.

In addition, on an outer wall surface of the multi-mode optical fiber, one protective synthetic resin layer or two protective synthetic resin layers are formed to cover the multi-mode optical fiber to protect the same from external impact.

The illumination intensity optical-cable 500 according to one embodiment may have a length of 10 cm to 1,000 cm.

Next, the condenser lens adjustment unit 600 according to one embodiment will be described in detail.

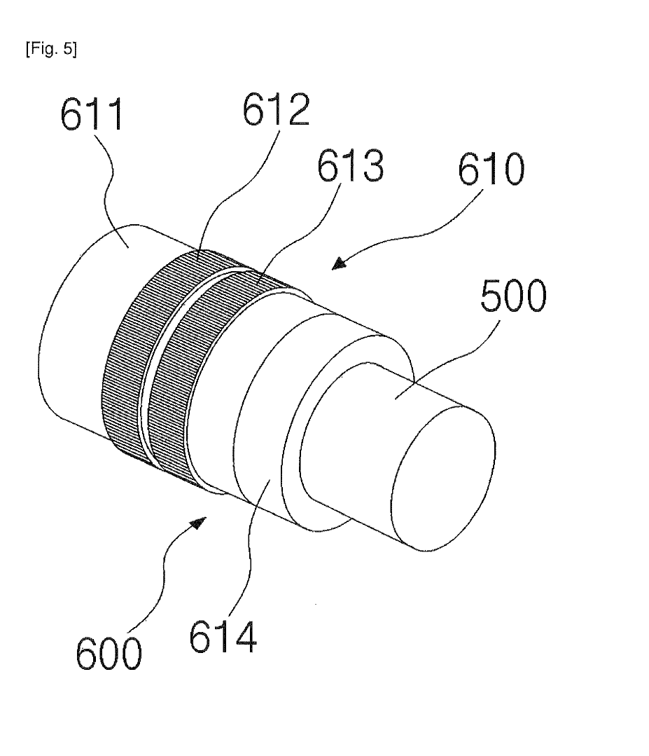

The condenser lens adjustment unit 600 is disposed exactly at an extension line of a length direction of the illumination intensity optical-cable 500 and to be spaced from an outlet end of the illumination intensity optical-cable 500. The condenser lens adjustment unit 600 condenses one beam of light diffused from the illumination intensity optical-cable 500 using the condenser lens 623 so that a focal point is formed at a particular position to be illuminated. Moreover, the condenser lens adjustment unit 600 adjusts a focal angle via focus and/or zoom adjustment of the condenser lens 623. The condenser lens adjustment unit 600 includes a condenser lens cover 610 and a condenser lens housing 620 to accommodate the condenser lens 623, as shown in FIG. 5.

The condenser lens cover 610 accommodates components of the condenser lens adjustment unit 600 and has a hollow cylindrical shape having opened front and rear sides.

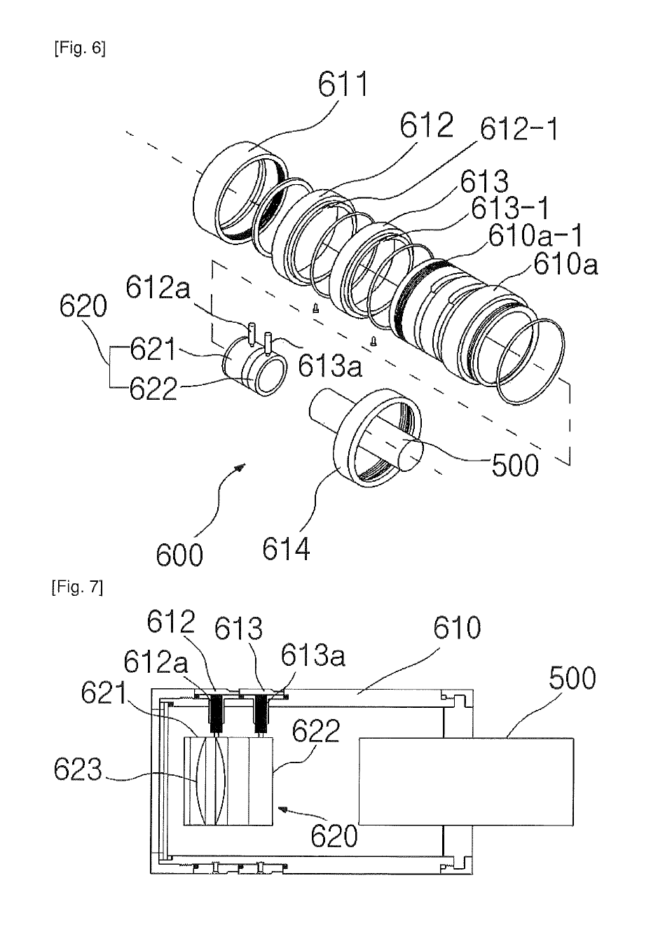

As shown in FIG. 6, the condenser lens cover 610 includes a hollow cylindrical body, a component formed in the body and components formed on an outer wall surface of the body.

On the outer wall surface of the cylindrical body, a front cover 611, a focus adjustment ring 612, a zoom adjustment ring 613 and a rear cover 614 are formed to be coaxially arranged from the front of the body to the rear of the body in this order.

The condenser lens housing 620 is formed within the cylindrical body.

Between the front cover 611 and focus adjustment ring 612 and zoom adjustment ring 613 and rear cover 614, corresponding O-rings are formed in a sealed manner.

On the outer wall surface of the cylindrical body, a plurality of threads 610a-1 is formed at regions corresponding to the focus adjustment ring 612 and zoom adjustment ring 613. Along the threads 610a-1, the focus adjustment ring 612 and/or zoom adjustment ring 613 may move forwards or backwards to carry out focus and/or zoom adjustment.

The focus adjustment ring 612 is coupled to the outer wall surface of the condenser lens cover 610 to control a focus adjustment unit 621 of the condenser lens housing 620. The focus adjustment ring 612 has a circular ring shape having an inner diameter corresponding to the size of a circumference of the outer wall surface of the condenser lens cover 610 so as to be rotatably coupled onto the outer wall surface of the condenser lens cover 610. At an inner wall surface of the focus adjustment ring 612, a coupling recess 612-1 with a concave shape is formed such that a focus adjustment rod 612a protruding from the condenser lens housing 620 along a first guide hole of the focus adjustment ring is coupled to the coupling recess 612-1.

The focus adjustment rod 612a is coupled to the condenser lens 623 beneath the rod 612a and supports the condenser lens 623 in a suspended manner.

The focus adjustment ring 612 may move forwards or backwards via a rotation thereof along a plurality of the threads 610a-1 formed on the outer wall surface of the cylindrical body while the focus adjustment rod 612a is coupled to the coupling recess 612-1 with the concave shape formed at the first guide hole. In this way, the focus adjustment ring 612 may adjust a focus formed by the condenser lens 623.

The zoom adjustment ring 613 is coupled onto the outer wall surface of the condenser lens cover 610 at a location adjacent to the focus adjustment ring 612 to control a cylindrical horizontal movement unit 622 of the condenser lens housing 620. The zoom adjustment ring 613 has a circular ring shape having an inner diameter corresponding to the size of a circumference of the outer wall surface of the condenser lens cover 610 so as to be rotatably coupled to the outer wall surface of the condenser lens cover 610. At an inner wall surface of the zoom adjustment ring 613, a coupling recess 613-1 with a concave shape is formed such that a zoom adjustment rod 613a protruding from the condenser lens housing 620 along a second guide hole of the zoom adjustment ring is coupled to the coupling recess 613-1.

The zoom adjustment rod 613a is coupled to a cylindrical horizontal movement unit 622 beneath the rod 613a.

The condenser lens housing 620 condenses one beam of light diffused from the illumination intensity optical-cable 500 using the condenser lens 623 so that a focal point is formed at a particular position to be illuminated. The condenser lens housing 620 includes the focus adjustment unit 621 and the cylindrical horizontal movement unit 622.

The focus adjustment unit 621 may adjust a focal point formed by the condenser lens 623. A focal point is formed at a particular position to be illuminated by condensing light diffused from the illumination intensity optical-cable 500 using the condenser lens 623. The focus adjustment unit 621 may move forwards or backwards via a rotation of thereof so that the condenser lens 623 may move forwards or backwards. Thus, a lens aperture of the condenser lens 623 is enlarged or reduced so that an image at the focal point is fuzzy or clear.

The cylindrical horizontal movement unit 622 has a zoom function. As the zoom adjustment ring 613 may move forwards or backwards via rotation thereof, the cylindrical horizontal movement unit 622 may horizontally move forwards or backwards, to enable the focus adjustment unit 621 connected to one side of the cylindrical horizontal movement unit 622 to move forwards or backwards. Accordingly, the size of the focal point is enlarged or reduced.

The cylindrical horizontal movement unit 622 is coupled to the zoom adjustment rod 613a at a top side thereof and is connected to the focus adjustment unit 621 at one side thereof.

The cylindrical horizontal movement unit 622 according to one embodiment has a hollow cylindrical form having open front and rear sides. The cylindrical horizontal movement unit 622 may horizontally move forwards or backwards while being spaced from the outlet end of the illumination intensity optical-cable 500, to enlarge or reduce the size of the focal point formed by the condenser lens 623.

The spacing between the cylindrical horizontal movement unit 622 and the outlet end of the illumination intensity optical-cable 500 may be set to 1.5 cm to 20 cm.

The above range is defined for the flowing reasons. When the spacing between the cylindrical horizontal movement unit 622 and the outlet end of the illumination intensity optical-cable 500 is below 1.5 cm, light passing through the condenser lens 623 may spread wide. Thus, it is difficult to form a focal point. On the other hand, when the spacing between the cylindrical horizontal movement unit 622 and the outlet end of the illumination intensity optical-cable 500 is above 20 cm, a focal point formed by the condenser lens 623 may not be located at a desired particular position. Therefore, the spacing between the cylindrical horizontal movement unit 622 and the outlet end of the illumination intensity optical-cable 500 is preferably set to 1.5 cm to 20 cm.

Hereinafter, operation of the LED light-concentrating device using the multiple optical-cables according to one embodiment will be described in detail.

First, the LED module 200 including a plurality of the high luminance LEDs generates beams of light.

At this time, heat generated from the high luminance LEDs is primarily discharged via the metal PCB 220.

In addition, remaining heat not discharged via the metal PCB 220 is secondarily discharged via the cooing water pipe 110a formed in the metal PCB 220.

Next, beams of light respectively emitted from the plurality of the high luminance LEDs are transferred through the multi-optical-fibers 300 directly connected to the corresponding high luminance LEDs to the optical-cable adaptor 400.

Here, the optical-cable adaptor 400 collects beams of light transferred through the multi-optical-fibers 300 and transfers the same to the illumination intensity optical-cable 500. The illumination intensity optical-cable 500 combines the beams of light into one beam of light.

Thereafter, light from the illumination intensity optical-cable 500 is transferred to the condenser lens adjustment unit 600 disposed exactly at an extension line of a length direction of the illumination intensity optical-cable 500 and spaced from an outlet end of the illumination intensity optical-cable 500. Then, the condenser lens adjustment unit 600 condenses the light diffused from the illumination intensity optical-cable 500 using the condenser lens 623 so that a focal point is formed at a particular position to be illuminated. In addition, the condenser lens adjustment unit 600 adjusts a focal angle via focus and/or zoom adjustment of the condenser lens 623.

Below, performance of the light-concentrating device using the multiple optical-cables according to one embodiment will be set forth based on experiments in terms of a ratio of an output light amount to an input light amount.

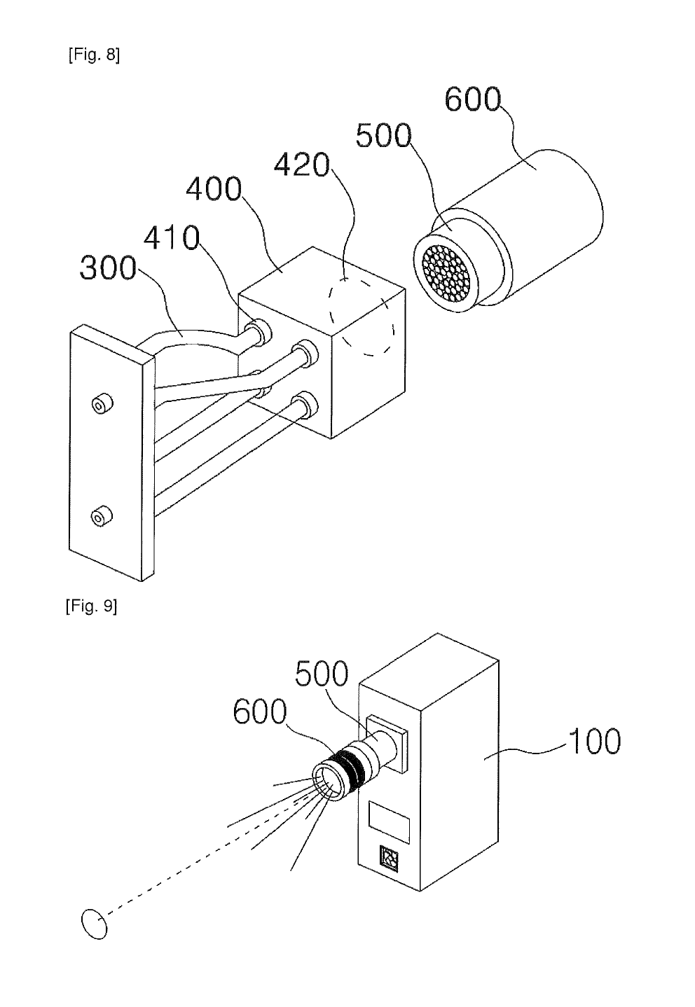

FIG. 8 is an exemplary perspective view illustrating a state in which an illumination intensity optical-cable 500 is connected to an optical-cable adaptor 400 to receive beams of light from the adaptor 400, combines the same into one beam of light and then transfers the combined beam to a condenser lens 623, according to one embodiment.

In the experiment, 4 high luminance LEDs were used to emit beams of light to the corresponding multi-optical-fibers. Each of the 4 high luminance LEDs is a 4 W Acriche (trademark of LED) having an output power of 11.8 W.

A first multi-optical-fibers are formed of φ4×1 m, a second multi-optical-fibers are formed of φ4×2 m, a third multi-optical-fibers are formed of φ4×3 m, and a fourth multi-optical-fibers are formed of φ4×4 m.

The illumination intensity optical-cable is formed of φ14×10 cm.

As mentioned above, in the experiment, the 4 multi-optical-fibers were used among a total of 8 multi-optical-fibers shown in FIG. 8. The 4 multi-optical-fibers used in the test have different lengths.

Measurements of light amounts output from the 4 multi-optical-fibers receiving beams of light emitted from the corresponding 4 high luminance LEDs are shown in the following table 1.

TABLE 1
Measurements of light amounts output from the
multi-optical-fibers

| | Measurements of light amounts | |
|---|---|---|
| | | Light amounts |
| | | output from |
| Multi-optical-fibers(dimensions) | Acriche | multi-optical-fibers |
| First multi-optical-fibers(φ4 × 1 m) | 25 k | 150 k |
| Second multi-optical-fibers(φ4 × 2 m) | 25 k | 150 k |
| Third multi-optical-fibers(φ4 × 3 m) | 25 k | 150 k |
| Fourth multi-optical-fibers(φ4 × 4 m) | 25 k | 110 k |

Measurements of light amounts output from the illumination intensity optical-cable sequentially receiving beams of light from the 4 multi-optical-fibers are shown in the following table 2. That is, the respective light amounts are produced by sequentially combining the beams of light from the 4 multi-optical-fibers using the illumination intensity optical-cable.

TABLE 2

| Measurements of light | | |
|---|---|---|
| amounts output from the | Measurements of light amounts | |
| illumination intensity optical-cable | | Light amounts output |
| Sequential combinations | | from the illumination |
| of multi-optical-fibers | Acriche | intensity optical-cable |
| First multi-optical-fibers + second | 45 k | 270 k |
| multi-optical-fibers | | |
| First multi-optical-fibers + second | 65 k | 385 k |
| multi-optical-fibers + third multi- | | |
| optical-fibers | | |
| First multi-optical-fibers + second | 85 k | 500 k |
| multi-optical-fibers + third multi- | | |
| optical-fiber + fourth multi-optical- | | |
| fibers | | |

In conclusion, light amounts output from the illumination intensity optical-cable when using a plurality of the multi-optical-fibers are proportional to the number of the multi-optical-fibers. In case when using the 4 multi-optical-fibers, a percentage of an output light amount to an input light amount becomes approximately 80% to 85%. When measuring light output in terms of length of a multi-optical-fiber, light amount loss is below 2% for the multi-optical-fibers that are 1 m in length.

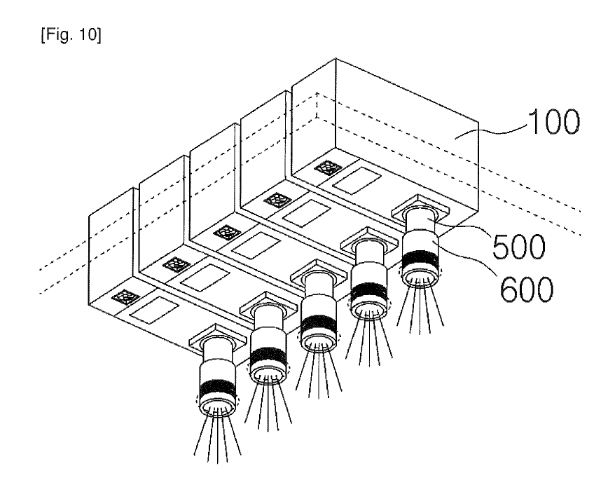

By this light amount enhancement, the light-concentrating devices using the multiple optical-cables according to one embodiment are installed, as shown in FIG. 10, to light a museum, swimming pool, building outer wall or building floor, or bridge, or as a lighting device for a semiconductor manufacturing process or surgical operation, etc.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A light-concentrating device comprising:
a. a body having a rectangular box form;
b. an LED module formed in the body and including a plurality of LED elements to generate a plurality of beams of light respectively;
c. a plurality of multi-optical-fibers directly connected to the corresponding LED elements of the LED module and transferring the beams of light emitted from the LED elements to an optical-cable adaptor;
d. the optical-cable adaptor having one side-end connected to the multi-optical-fibers while having the other side-end connected to an illumination intensity optical-cable and collecting the beams of light output from the multi-optical-fibers and transferring the beams of light to the illumination intensity optical-cable;
e. the illumination intensity optical-cable connected to the optical-cable adaptor to receive the beams of light from the optical-cable adaptor and combine the beams of light into one beam of light and then to transfer one beam of light to a condenser lens; and
f. a condenser lens adjustment unit disposed at an extension line of a length direction of the illumination intensity optical-cable and spaced from an outlet end of the illumination intensity optical-cable, wherein the condenser lens adjustment unit condenses one beam of light diffused from the illumination intensity optical-cable using the condenser lens provided therein so that a focal point is formed at a particular position to be illuminated and the condenser lens adjustment unit adjusts a focal angle via focus and/or zoom adjustment of the condenser lens.

2. The device according to claim 1, wherein the LED module comprises
a. a plurality of LED light-collecting head caps, each head cap surrounding a light-emission end of each of the LED elements and collecting beams of light toward a centrally-formed insertion hole by reflecting outside-directed beams of light and guiding the collected beams of light to an insertion tube side of each of the multi-optical-fibers inserted into the insertion hole,
b. wherein the LED light-collecting cap immovably supports the insertion tube.

3. The device according to claim 1, wherein each of the multi-optical-fibers comprises a circular-shaped insertion tube inserted into an insertion hole of each of LED light-collecting head caps of the LED module.

4. The device according to claim 1, wherein the condenser lens adjustment unit comprises a focus adjustment ring having a circular ring shape having an inner diameter corresponding to a size of a circumference of an outer wall surface of a condenser lens cover so as to be rotatably coupled to the outer wall surface of the condenser lens cover,

5. wherein at an inner wall surface of the focus adjustment ring, a coupling recess with a concave shape is formed such that a focus adjustment rod protruding from a condenser lens housing along a first guide hole of the focus adjustment ring is coupled to the coupling recess.

6. The device according to claim 1, wherein the condenser lens adjustment unit comprises a condenser lens housing condensing light diffused from the illumination intensity optical-cable using a condenser lens provided therein so that a focal point is formed at a particular position to be illuminated.

7. The device according to claim 6, wherein the condenser lens housing comprises:
a. a focus adjustment unit adjusting a focus formed by the condenser lens; and
b. a cylindrical horizontal movement unit horizontally moving forwards or backwards via a rotation of a zoom adjustment ring, to enable itself the focus adjustment unit connected to one side of the cylindrical horizontal movement unit to move forwards or backwards so that a size of the focal point is enlarged or reduced.

8. A light-concentrating device comprising:
a. a housing;
b. a light emitting diode (LED) module within the housing further comprising a plurality of LED elements wherein the LED elements individual beams of light;
c. a plurality of optical-fibers optically connected to corresponding LED elements of the LED module and directing the individual beams of light emitted from the LED elements to an optical-cable adaptor;
d. the optical-cable adaptor optically connected to the optical-fibers and optically connected to an illumination intensity optical-cable,
e. wherein the optical-cable adapter receives individual beams of light output from the optical-fibers and directs the individual beams of light to the illumination intensity optical-cable;
f. the illumination intensity optical-cable connected to the optical-cable adaptor to direct the combined beam of light to a condenser lens adjustment unit; and
g. the condenser lens adjustment unit optically connected to the illumination intensity optical-cable and spaced from an outlet end of the illumination intensity optical-cable, and;
h. wherein the condenser lens adjustment unit condenses the combined beam of light directed from the illumination intensity optical-cable using the condenser lens provided therein such that a condensed light region is formed at a particular position to be illuminated.
